(19) United States
(12) Patent Application Publication
(10) Pub. No.: US 2021/0216681 A1
(43) Pub. Date: Jul. 15, 2021

(54) METHOD FOR DESIGNING SVE PROCESS PARAMETERS IN PETROLEUM-TYPE POLLUTED FIELD

(71) Applicants: Technical Centre for Soil, Agricultural&Rural Ecology&Environment, Ministry of Ecology&Environment, Beijing (CN); Chinese Research Academy of Environmental Sciences, Beijing (CN)

(72) Inventors: Juan Li, Beijing (CN); Yang Yang, Beijing (CN); Beidou Xi, Beijing (CN); Ying Wang, Beijing (CN); Junxiang Shi, Beijing (CN); Yang Wang, Beijing (CN); Haojie Lu, Beijing (CN); Jun Tang, Beijing (CN); Ningqing LV, Beijing (CN)

(21) Appl. No.: 17/060,937

(22) Filed: Oct. 1, 2020

Related U.S. Application Data
(63) Continuation of application No. PCT/CN2020/077574, filed on Mar. 3, 2020.

(30) Foreign Application Priority Data
Jan. 15, 2020 (CN) 202010042282.7

(51) Int. Cl. G06F 30/20

(52) U.S. Cl. CPC G06F 30/20; B09C 1/00

(57) ABSTRACT

The present disclosure discloses a method for designing SVE process parameters in a petroleum-type polluted field. The method includes the steps of: first step, clarifying the conditions of the field and the petroleum-type pollution; second step, by referring to field parameters, pollution parameters and SVE process parameters, establishing an SVE remediation model by using a TOUGH software and obtaining remediation rates; the third step, by using the method of grey correlation degree, screening p main control factors; fifth step, performing fitting verification to the results of simulation according to a multi-variable equation of linear regression, and judging whether the simulation accuracy satisfies design requirements; and sixth step, screening an optimum combination of the SVE process parameters and applying the combination.

### TECHNICAL FIELD

The present disclosure relates to the technical field of control of petroleum-type polluted fields, and particularly relates to a method for designing SVE process parameters in a petroleum-type polluted field.

### BACKGROUND

Along with the development of industrialization, the utilization of petroleum is increasing. In long-term usage, leakage of petroleum frequently happens, and petroleum-type pollution is increasingly becoming an important part of environmental pollution. Because petroleum-type organic pollutants have volatility and fluidity, they migrate in soil layers of higher permeability and even permeate into underground water, and result in pollution in a larger area under the water-soil interaction, to aggravate the pollution.

To control petroleum-type pollutants, the process of the migration and conversion of the petroleum-type pollutants in soil should be clearly known. TOUGH, as the abbreviation in English of Transport of Unsaturated Groundwater and Heat, is a numerical-value simulator program that simulates the migration of multi-phase flow (multi2phase), multi-component (multi2 component) and non-isothermal (non2isothermal) water flow and heat in one-dimensional, two-dimensional and three-dimensional pore or crevice media. By simulating petroleum-type polluted fields by using the TOUGH software, the process of the migration and conversion of petroleum-type pollutants can be accurately known.

Among the techniques of controlling petroleum-type polluted fields, Soil Vapor Extraction (SVE) is an approach of in-situ remediation for soil volatile-organic-substance pollution, and is used to handle the pollution of the geological media of vadose zones. Currently, studies on the SVE mostly stay at the stages of laboratory experimentation and field tests, the design and operation of the studies are mostly performed according to empirical formulas or in limited fields, and there is little study aiming at SVE numerical-value simulation. No design exists with respect to the influence factors and their weights of influence for the application of the SVE remediation to different fields and different pollutants, no design exists with respect to the combination of SVE technical parameters and mathematical models, and no design exists with respect to the verification on the applicability for different fields.

### SUMMARY

The present disclosure provides a method for designing SVE process parameters in a petroleum-type polluted field, to solve the technical problems of the influence on the SVE remediation rate of the different influence factors in the petroleum-type polluted field, the screening of the different influence factors, the combined application of mathematical models, and the verification on the equation models of SVE process parameters.

In order to realize the above objects, the present disclosure employs the following technical solutions:

A method for designing SVE process parameters in a petroleum-type polluted field, wherein the method comprises the particular steps of:

first step, according to results of practical field reconnaissance, in-situ test and soil test, by referring to geological data of the field, clarifying conditions of the field such as geological type, soil type and distribution and underground-water distribution; and determining type and position of petroleum-type pollution;

second step, by referring to field parameters, pollution parameters and SVE process parameters, establishing by using a TOUGH software a remediation model with respect to SVE (Soil Vapor Extraction) of the petroleum-type polluted field, and obtaining SVE remediation rates under different conditions of influence factors;

wherein the SVE remediation rates reflect effect of the SVE on removal of the petroleum-type pollution in the field, and a calculating formula of the SVE remediation rate yₖ is as shown below:

$${y}_{k} = \frac{{m}_{k} - {m}_{k}^{′}}{{m}_{k}}$$

wherein in the formula: mₖ is a total mass of pollutants to be removed in an SVE pre-remediation model in a unit of kg; mₖ′ is a total mass of pollutants in an SVE post-remediation model in a unit of kg; wherein k=1, 2, 3, . . . , w, wherein w is a quantity of fields;

the third step, by using a method of grey-correlation-degree analysis, comparing and ranking correlation degrees of the SVE at the remediation rates of different influence factors for different field types, and screening p main control factors by using rank positions;

wherein a sequence of serial numbers of the different fields is counted as k (k=1, 2, 3, . . . n), wherein Xi are set as the influence factors of the SVE remediation rate, and xᵢ(k) is set as observed data of the factor xᵢ at the field k; then {xᵢ(k)|k=1, 2, 3, . . . , n} is an SVE-effect-action sequence, wherein i=1, 2, 3, . . . , m, and m is a quantity of the influence factors; and y(k) is set to be the SVE remediation rate of the field k;

wherein calculation of the correlation degrees r, is as shown below:

$${r}_{i} ( y , {x}_{i} ) = \frac{1}{n} {\sum }_{k = 1}^{n} {ζ}_{i} ( k )$$

wherein in the formula, ζᵢ(k) are correlation-degree coefficients;

fourth step, by using grey-correlation-degree analysis, screening p main control factors that are correlated with the SVE remediation rate, and establishing a multi-variable equation of linear regression between the remediation rate y as dependent variable and the main control factors Xᵢ (i=1, 2, . . . , p) as independent variables;

wherein the multi-variable equation of linear regression between y and the p main control factors Xᵢ is as shown below:

y=b₀+b₁X₁+b₂X₂+ . . . +bₚXₚ,

wherein in the formula, among b₀, b₁, b₂, . . . , bₚ, b₀ is a constant quantity and the others are undetermined coefficients of the p main control factors; and solving by using least square method and the other undetermined coefficients of the multi-variable equation of linear regression;

fifth step, based on a result of simulation of the multi-variable equation of linear regression, by means of goodness of fit, performing test and judging accuracy of the simulation; then judging by using significance test a significance of the model and a significance of the parameters of the multi-variable equation of linear regression; and finally performing accuracy comparison to the error of the model of the multi-variable equation of linear regression, to judge whether the accuracy satisfies design requirements; and

sixth step, by using the established multi-variable equation of linear regression, substituting characteristic parameters of a new field that have been already known into the multi-variable equation of linear regression, and, by setting a target of the SVE remediation rate, screening an optimum combination of the SVE process parameters, to provide technical reference for parameter design of polluted-field SVE remediation technique.

Optionally, selection of the field in the first step is a representative typical land parcel or comprises dividing a land parcel according to geology into areas, and conceptualizing vertical soil-quality layers of the field, wherein the conceptualization of the soil-quality layers include a petroleum-type-organic-pollutant migrated and transformed soil layer and an SVE applied soil layer.

Optionally, the second step comprises performing TOUGH-software conceptualization simulation by using multiple typical polluted fields, obtaining influences on the SVE remediation rate by the different influence factors of the field parameters, the pollution parameters and the SVE process parameters, obtaining the corresponding SVE remediation rate, and performing comparison-simulation to amplitudes of variation of magnitudes of the same influence factors.

Optionally, in the second step, the selected influence factors of SVE remediation efficiency include, as the field parameters, infiltration capacity, thickness of unsaturated zone, porosity, permeability, oxygen content, temperature and pH value; as the pollution parameters, pollutant type, depth, width and area; and as the SVE process parameters, flow rate inside extraction well, radius of influence, depth of extraction well and quantity of extraction wells.

Optionally, a process of the TOUGH-software simulation comprises selecting different modules according to different pollutants, wherein the modules include a T2VOC module and a TMVOC module; the T2VOC module is a three-phase flow of three components, and comprises simulations of numerical values of water, air and VOC, and the TMVOC modulemulation is simulations of numerical values of water, soil gas and multi-component mixed volatile organic compounds in a three-phase non-isothermal flow in a multi-layer, anisotropic, porous medium; and the process of the TOUGH-software simulation performs visualized operation by using a PetraSim software.

Optionally, the process of the TOUGH-software simulation comprises, for different pollutants, by setting the same initial parameters such as leakage speed, leakage point and leakage duration, and the same field parameters and SVE process parameters, and by using an existing calibration model of experimentation data or field data, obtaining SVE remediation rates that are comparable.

Optionally, in the fourth step, the calculation of the correlation degrees r, is as follows:

1st step, nondimensionalization, as shown below:

$${x}_{i}^{′} ( k ) = \frac{{x}_{i} ( k )}{{\overline{X}}_{ι}} , {\overline{X}}_{ι} = \frac{1}{n} {\sum }_{k = 1}^{n} {x}_{i} ( k )$$

$$k = 1 , 2 , … , n$$

2nd step, evaluation of sequence of difference, as shown below:

Δᵢ(k)=|y(k)−xᵢ′(k)|

i=1,2, . . . ,m; k=1,2, . . . ,n

3rd step, solving two grades of maximum difference and minimum difference, as shown below:

$$M = {max }_{i} {max }_{k} {Δ}_{i} ( k ) m , m = {min}_{i} {min}_{k} {Δ}_{i} ( k ) m$$

4th step, solving correlation coefficients, as shown below:

$${ζ}_{i} ( k ) = \frac{m + ρ M}{{Δ}_{i} ( k ) + ρ M} , ρϵ [ 0 , 1 ]$$

$$i = 1 , 2 , … , m ; k = 1 , 2 , … , n$$

5th step, calculation of the correlation degrees rᵢ, as shown below:

$${r}_{i} ( y , {x}_{i} ) = \frac{1}{n} {\sum }_{k = 1}^{n} {ζ}_{i} ( k )$$

$$i = 1 , 2 , … , m$$

Optionally, in the fifth step, a fitting degree of the model of the multi-variable equation of linear regression is tested by using goodness of fit;

wherein a formula of the test of goodness of fit is as shown below:

$${R}^{2} = \frac{E S S}{TSS} = 1 - \frac{R S S}{TSS} , 0 \leq {R}^{2} \leq 1$$

wherein in the formula: TSS is a sum of squares for total, ESS is a regression sum of square, and RSS is a residual sum of square; and if R² is closer to 1, a degree of fitting of the model of the multi-variable equation of linear regression is better.

Optionally, in the fifth step, the significance test of the multi-variable equation of linear regression is as shown below:

$$F = \frac{E S S / p}{R S S / ( n - p - 1 )} ∼ F ( p , n - p - 1 )$$

wherein in the formula, n is a sample size, and p is a selected variable; if F≥F_{α}(p, n−p−1), the regression model has significance; and if F<F_{α}(p, n−p−1), the regression model has no significant difference, i.e., the regression model is not significant;

wherein the significance test of the parameters is as shown below:

$$t = \frac{{b}_{i}}{S ( {b}_{i} )}$$

wherein in the formula, b₀ represents regression coefficients, and S(bᵢ) represents a standard deviation of the regression coefficients; if

$$\vert t \vert \geq {t}_{\frac{α}{2}} ( n - p - 1 ) ,$$

that indicates that xᵢ has a significant influence on y; and if

$$\vert t \vert < {t}_{\frac{α}{2}} ( n - p - 1 ) ,$$

that indicates that xᵢ does not have a significant influence on y; wherein a test of t-value of the parameters is able to be simplified into a probability test, and if a probability of the t-value is less than 0.05, the independent variable is significant.

Optionally, in the fifth step, error analysis of the multi-variable equation of linear regression comprises the particular steps of:

\textcircled{1} solving an mean value Y̅ of raw data, as shown below:

$$\overline{Y} = \frac{1}{n} {\sum }_{k = 1}^{n} Y ( k )$$

\textcircled{2} solving a variance S₁ of the raw data, as shown below:

$${S}_{1}^{2} = \frac{1}{n} {\sum }_{k = 1}^{n} {[ Y ( k ) - \overline{Y} ]}^{2}$$

\textcircled{3} solving a mean value ε of residual errors, as shown below:

$$ɛ ( k ) = Y ( k ) - {Y}^{′} ( k )$$

$$\overline{ɛ} = \frac{1}{n} {\sum }_{k = 1}^{n} ɛ ( k )$$

\textcircled{4} solving a variance of the residual errors, as shown below:

$${S}_{1}^{2} = \frac{1}{n} {\sum }_{k = 1}^{n} {[ ɛ ( k ) - \overline{ɛ} ]}^{2}$$

\textcircled{5} calculating a variance ratio C and a small-error probability P, as shown below:

$$C = \frac{{S}_{2}}{{S}_{1}}$$

$$P = \{ \vert ɛ ( k ) - \overline{ɛ} \vert < 0. 6745 {S}_{1} \}$$

when the posterior-error ratio C is less than 0.5, the accuracy of the model is considered as qualified, and if C is smaller, the accuracy of the model is higher; and when the small-error probability P is greater than 0.8, the accuracy of the model is considered as qualified, and if P is larger, the accuracy of the model is higher.

The advantageous effects of the present disclosure are as follows:

1) The present disclosure, by using the design involving multiple fields and multiple factors, and simulating the conditions of pollution in different scenes by using the TOUGH software, can clarify the rule of the migration of the petroleum-type pollutants in the fields in the different scenes, to determine the polluted area, which facilitates the latter parameter design for the SVE process.

2) The present disclosure, based on the method of grey correlation degree, ranks the different influence factors of a typical field, to find out the main control factor, which facilitates using the key design in the SVE process design for the same type of pollutions on the same type of land parcels, and improves the application efficiency.

3) The present disclosure, by establishing the multi-variable equation of linear regression, further ranks and corrects the main control factors that are related to the SVE remediation rates, to enable them to be more applicable for the corresponding similar typical fields.

4) The present disclosure, by approaches such as goodness of fit, significance test and error test, further ensures the accuracy and the reliability of the multi-variable equation of linear regression in practical applications.

Furthermore, the present disclosure can perform individual simulation and design according to different fields and corresponding pollutants, and can also preset the related influence parameters according to the previous and existing designs, and then perform the screening of the correlation degrees, thereby providing a good applicability. The other characteristics and advantages of the present disclosure will be described in the subsequent description, and partially become apparent from the description or be understood by the implementation of the present disclosure. The main object and the other advantages of the present disclosure can be realized and obtained by implementing the solutions particularly described in the description.

### BRIEF DESCRIPTION OF THE DRAWINGS

FIG. 1 is a schematic flow chart of the method for designing an SVE process parameter in a field polluted by BTEX, a petroleum-type pollutant;

FIG. 2 is a schematic diagram of the PetraSim-software visualization of the BTEX-polluted field based on TOUGH-software simulation;

FIG. 3 is a schematic diagram of the section of the BTEX pollution of the S1 polluted field; and

FIG. 4 is a schematic diagram of the section of the extraction technique for the BTEX pollution of the S1 polluted field that should be employed.

### DETAILED DESCRIPTION

BTEX pollution is a representative one of pollutions caused by petroleum-type organic pollutants. BTEX is the general term of benzene, toluene, ethylbenzene, and the three isomers of xylene (o-xylene, m-xylene and p-xylene), which are commonly found in petroleum, and is a simple-aromatic-hydrocarbon type substance. BTEX mainly exists in crude oil and petroleum products, and, as a chemical raw material, is extensively applied to sections such as pesticide, plastic and synthetic fiber. BTEX is easily releasable into environment during production, storage and transportation, to cause environmental pollution, and to harm the ecosystem and human health. In the control of BTEX pollution, because BTEX is volatile, it can be removed by SVE in soils of a high permeability.

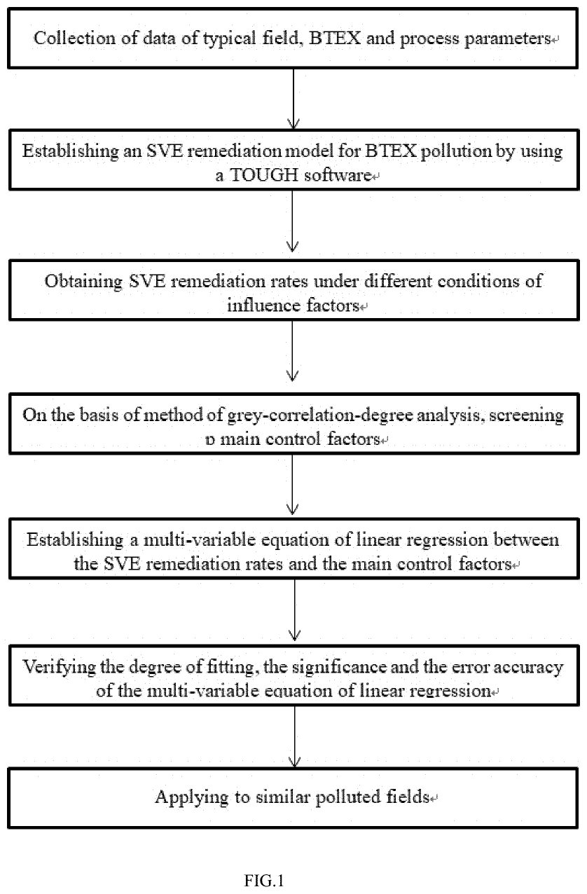

By taking BTEX as the example, as shown in FIG. 1, a schematic flow chart of the method for designing an SVE process parameter in a BTEX-polluted field, the method comprises the following particular steps:

First step, according to results of practical field reconnaissance, in-situ test and soil test, by referring to geological data of the field, clarifying conditions of the field such as geological type, soil type and distribution and underground-water distribution; and determining type and position of petroleum-type pollution.

Selection of the field in the first step is a representative typical land parcel or comprises dividing a land parcel according to geology into areas, and conceptualizing vertical soil-quality layers of the field, wherein the conceptualization of the soil-quality layers include a petroleum-type-organic-pollutant migrated and transformed soil layer and an SVE applied soil layer.

According to the different physical and chemical parameters such as density, vapour pressure and solubility of the BTEXs, in the present embodiment the design of the simulation of BTEX pollution in different fields is performed by using the data that are collected from 15 typical areas (represented by S1, S2, S3, . . . , S15) of China, and the field parameters of the 15 typical areas are as shown in Table 1.

TABLE 1
the field parameters

| | Annual | Unsaturated zone | | | | Saturated zone | | | |
|---|---|---|---|---|---|---|---|---|---|
| | penetration | Soil | | | | Soil | | | |
| Field | amount/mm | type | Thickness/m | Porosity | Permeability/m2 | type | Thickness/m | Porosity | Permeability/m2 |
| S1 | 133.20 | Sandy | 2 | 0.34 | 1.50E−11 | Silty | 3 | 0.45 | 2.78E−14 |
| | | soil | | | | clay | | | |
| S2 | 324.28 | Sandy | 24 | 0.29 | 1.08E−11 | Sandy | 8 | 0.29 | 1.00E−11 |
| | | soil | | | | soil | | | |
| S3 | 680 | Sandy | 9.5 | 0.41 | 1.00E−12 | Sandy | 5.5 | 0.41 | 1.00E−12 |
| | | soil | | | | soil | | | |
| S4 | 59.15 | Loam | 1.5 | 0.42 | 1.76E−13 | Silty | 3.5 | 0.45 | 2.78E−14 |
| | | soil | | | | clay | | | |
| S5 | 658 | Loam | 3.5 | 0.39 | 3.25E−11 | Sandy | 5.5 | 0.34 | 2.26E−10 |
| | | soil | | | | soil | | | |
| S6 | 193.95 | Loam | 5 | 0.41 | 9.10E−13 | Sandy | 3 | 0.41 | 1.00E−12 |
| | | soil | | | | soil | | | |
| S7 | 172.20 | Sandy | 2 | 0.43 | 3.64E−12 | Sandy | 6 | 0.41 | 1.00E−12 |
| | | soil | | | | soil | | | |
| S8 | 211.32 | Silty | 3.5 | 0.45 | 1.37E−14 | Sandy | 4 | 0.3 | 2.00E−11 |
| | | clay | | | | soil | | | |
| S9 | 115.50 | Loam | 5.5 | 0.41 | 2.15E−13 | Silty | 4.5 | 0.45 | 5.88E−14 |
| | | soil | | | | clay | | | |
| S10 | 172.40 | Silt | 6 | 0.4 | 3.41E−14 | Sandy | 5 | 0.34 | 2.26E−10 |
| | | | | | | soil | | | |
| S11 | 287.58 | Loam | 9.5 | 0.49 | 6.92E−13 | Clay | 5.5 | 0.5 | 5.79E−13 |
| | | soil | | | | | | | |
| S12 | 61.73 | Silty | 5.5 | 0.45 | 2.78E−14 | Sandy | 6.5 | 0.41 | 1.00E−12 |
| | | clay | | | | soil | | | |
| S13 | 487.24 | Clay | 12 | 0.45 | 1.90E−14 | Sandy | 8 | 0.41 | 1.00E−12 |
| | | | | | | soil | | | |
| S14 | 257.16 | Silty | 1.5 | 0.45 | 1.19E−13 | Sandy | 6.5 | 0.34 | 3.32E−11 |
| | | clay | | | | soil | | | |
| S15 | 389.72 | Silty | 4.5 | 0.45 | 8.38E−14 | Sandy | 5.5 | 0.41 | 2.13E−13 |
| | | clay | | | | soil | | | |

Second step, by referring to field parameters, pollution parameters and SVE process parameters, establishing by using a TOUGH software a remediation model with respect to SVE (Soil Vapor Extraction) of the petroleum-type polluted field, and obtaining SVE remediation rates under different conditions of influence factors.

The SVE remediation rates reflect effect of the SVE on removal of the petroleum-type pollution in the field, and a calculating formula of the SVE remediation rate yₖ is as shown in Formula (1):

$${y}_{k} = \frac{{m}_{k} - {m}_{k}^{′}}{{m}_{k}} \qquad ( 1 )$$

wherein in the formula: mₖ is a total mass of BTEX to be removed in an SVE pre-remediation model in a unit of kg; mₖ′ is a total mass of BTEX in an SVE post-remediation model in a unit of kg; wherein k=1, 2, 3, . . . , w, wherein w is a quantity of fields.

The selected influence factors of SVE remediation efficiency include, as the field parameters, infiltration capacity, thickness of unsaturated zone, porosity, permeability, oxygen content, temperature and pH value; as the pollution parameters, pollutant type, depth, width and area; and as the SVE process parameters, flow rate inside extraction well, radius of influence, depth of extraction well and quantity of extraction wells.

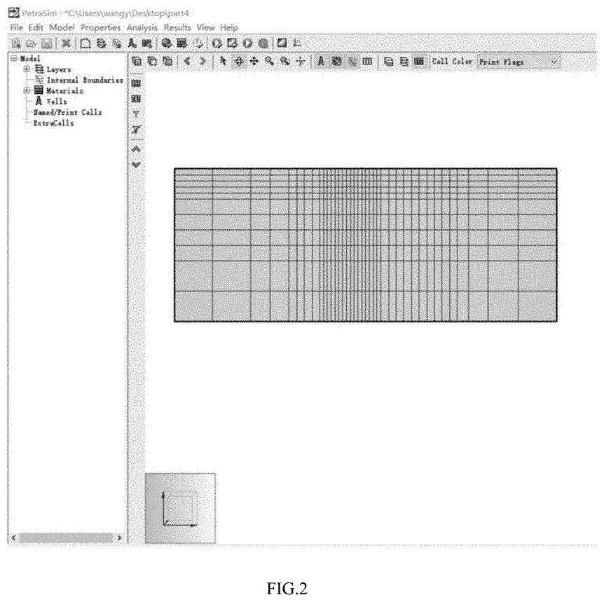

This step comprises performing process simulation by using the TOUGH software, selecting the TMVOC submodule of the TOUGH software according to the BTEX to establish the model, and performing visualized operation by a PetraSim software. By taking the S1 field as the example, the process comprises the establishing of the conceptual model, the fundamental parameter setting, the setting of the boundary conditions and the initial conditions, the operation and debugging of the model and the final establishing of the complete model. The interface for the model establishing is as shown in FIG. 2. The simulation of BTEX leakage and migration is performed to the 15 fields, wherein the speeds and the locations of leakage of the BTEXs are set to be the same, and the leakage durations are set to be 1 year. The states of pollution of the fields after the BTEX leakage and migration are as shown in Table 2, wherein NAPL refers to Non-aqueous Phase Liquid, and is a phase state with which the BTEXs exist in the fields.

TABLE 2
the simulated values of pollution of the fields after
the BTEX leakage and migration

| | | | | NAPL | |
|---|---|---|---|---|---|
| | Pollution | Pollution | Pollution | maximum | BTEX |
| Field | depth/m | width/m | area/m² | saturation | mass/kg |
| S1 | 2.5 | 96 | 144 | 0.147 | 2372.87 |
| S2 | 24 | 95 | 1140 | 0.060 | 2383.18 |
| S3 | 15 | 77.5 | 637.5 | 0.122 | 2330.05 |
| S4 | 2.5 | 37 | 74 | 0.630 | 2281.51 |
| S5 | 4.5 | 66 | 119.5 | 0.051 | 805.98 |
| S6 | 8 | 75 | 422 | 0.166 | 2345.63 |
| S7 | 2.5 | 64 | 121 | 0.242 | 2476.79 |
| S8 | 4.5 | 15 | 52 | 0.228 | 1579.94 |
| S9 | 7 | 23.5 | 147 | 0.393 | 2326.89 |
| S10 | 8 | 69 | 213 | 0.383 | 2170.30 |
| S11 | 2.5 | 46 | 80 | 0.199 | 1508.33 |
| S12 | 5 | 10.5 | 40.5 | 0.243 | 1349.46 |
| S13 | 6.5 | 11 | 31.5 | 0.247 | 1214.27 |
| S14 | 3 | 66 | 133 | 0.114 | 1112.01 |
| S15 | 7 | 12 | 66 | 0.247 | 1945.88 |

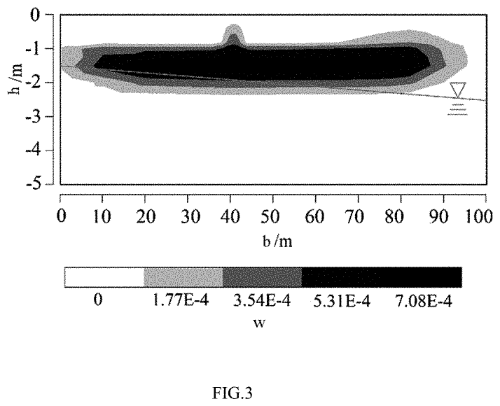

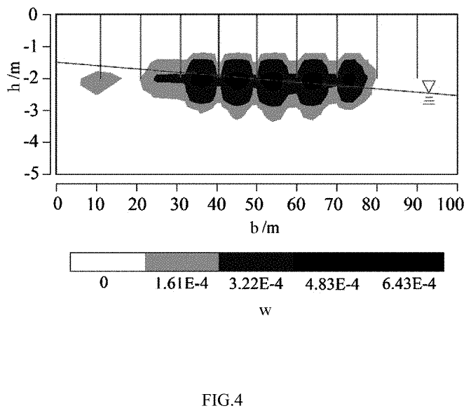

By taking the S1 field as the example, the distribution of the BTEX pollution before the model extraction is as shown in FIG. 3, and the extraction process is as shown in FIG. 4. In the drawings, h represents the depths, b represents the widths, w represents the mass fractions of the BTEX, and the triangle is the water level of the underground water. In FIG. 4 the vertical line segments that are distributed with spacings at the depth of Om are extraction wells. Accordingly, the states of BTEX pollution are simulated corresponding to the fields, and the SVE extraction parameters of the fields are designed as shown in Table 3.

TABLE 3
SVE extraction parameters of the fields

| | | Flow | | | |
|---|---|---|---|---|---|
| | Pressure | rate | Radius | | Quantity |
| | of | inside | of | Depth of | of |
| | extraction | well | influence/ | extraction | extraction |
| Field | well Pa | m3/s | m | well/m | wells |
| S1 | 9.10E4 | 2.44E−02 | 5 | 2 | 9 |
| S2 | 9.10E4 | 2.48E−01 | 2.5 | 24 | 2 |
| S3 | 9.10E4 | 5.76E−03 | 24 | 9.5 | 1 |
| S4 | 9.60E4 | 9.73E−05 | 7 | 1.5 | 4 |
| S5 | 9.10E4 | 8.39E−02 | 8 | 3.5 | 1 |
| S6 | 9.10E4 | 2.76E−03 | 24 | 5 | 1 |
| S7 | 9.10E+4 | 4.81E−03 | 3.5 | 1.9 | 9 |
| S8 | 9.10E+4 | 3.15E−05 | 15 | 3.5 | 1 |
| S9 | 9.10E+4 | 7.76E−04 | 15 | 5.5 | 1 |
| S10 | 9.10E+4 | 1.34E−04 | 15 | 6 | 4 |
| S11 | 9.10E+4 | 1.31E−03 | 7 | 2.5 | 4 |
| S12 | 9.10E+4 | 1.13E−04 | 8 | 5.5 | 1 |
| S13 | 9.10E+4 | 8.01E−05 | 16 | 6.5 | 1 |
| S14 | 9.10E+4 | 1.08E−02 | 5 | 1.7 | 5 |
| S15 | 9.10E+4 | 2.66E−04 | 10 | 4.5 | 1 |

The SVE remediation rates are calculated according to the statistics of the BTEXs in the fields before and after the SVE simulation, as shown in Table 4.

TABLE 4
the simulated values of the SVE
removal rates of the fields

| | Simulated value of SVE |
|---|---|
| Field | removal rate (Yᵢ) |
| S1 | 0.72 |
| S2 | 0.75 |
| S3 | 0.60 |
| S4 | 0.62 |
| S5 | 0.75 |
| S6 | 0.50 |
| S7 | 0.99 |
| S8 | 0.29 |
| S9 | 0.44 |
| S10 | 0.56 |
| S11 | 0.83 |
| S12 | 0.24 |
| S13 | 0.09 |
| S14 | 0.87 |
| S15 | 0.36 |

The third step, by using a method of grey-correlation-degree analysis, comparing and ranking correlation degrees of the SVE at the remediation rates of different influence factors for different field types, and screening p main control factors by using rank positions.

A sequence of serial numbers of the different fields is counted as k (k=1, 2, 3, . . . , n), wherein Xi are set as the influence factors of the SVE remediation rate, and xᵢ(k) is set as observed data of the factor xᵢ at the field k; then {xᵢ(k)|k=1, 2, 3, . . . , n} is an SVE-effect-action sequence, wherein i=1, 2, 3, . . . , m, and m is a quantity of the influence factors; and y(k) is set to be the SVE remediation rate of the field k;

1st step, nondimensionalization, as shown in Formula (2):

$${x}_{i}^{′} ( k ) = \frac{{x}_{i} ( k )}{{\overline{X}}_{ι}} , {\overline{X}}_{ι} = \frac{1}{n} {\sum }_{k = 1}^{n} {x}_{i} ( k ) \qquad ( 2 )$$

2nd step, evaluation of sequence of difference, as shown in Formula (3):

Δᵢ(k)=|y(k)−xᵢ′(k)| (3)

3rd step, solving two grades of maximum difference and minimum difference, as shown in Formula (4):

$$M = {max }_{i} {max }_{k} {Δ}_{i} ( k ) m , m = {min}_{i} {min}_{k} {Δ}_{i} ( k ) m \qquad ( 4 )$$

4th step, solving correlation coefficients, as shown in Formula (5):

$${ζ}_{i} ( k ) = \frac{m + ρ M}{{Δ}_{i} ( k ) + ρ M} , ρϵ [ 0 , 1 ] \qquad ( 5 )$$

5th step, calculating the correlation degrees, as shown in Formula (6):

$${r}_{i} ( y , {x}_{i} ) = \frac{1}{n} {\sum }_{k = 1}^{n} {ζ}_{i} ( k ) \qquad ( 6 )$$

There are 11 influence factors for selecting the SVE remediation efficiencies, including, as the field parameters, infiltration capacity (x₁), thickness of the unsaturated zone (x₂), porosity (x₃) and permeability (x₄); as the pollution parameters, pollution depth (x₅), width (x₆) and area (x₇); and, as the extraction parameters, flow rate inside well (x₈), radius of influence (x₉), depth of extraction well (x₁₀) and quantity of extraction wells (x₁₁). The numerical values of the parameters are as shown in Table 5.

TABLE 5
the calculation results of the grey correlation degrees

| | Field parameter | | | | Pollution parameter | | | Extraction parameter | | | |
|---|---|---|---|---|---|---|---|---|---|---|---|
| | | Thickness | Porosity | | | | | Flow | | Depth | Quantity |
| | | of | of | Permeability | | | | rate | Radius | of | of |
| | Infiltration | unsaturated | unsaturated | of unsaturated | Pollution | Pollution | Pollution | inside | of | extraction | extraction |
| | capacity | zone | zone | zone | depth | width | area | well | influence | well | wells |
| Parameter No. | x₁ | x₂ | x₃ | x₄ | x₅ | x₆ | x₇ | x₈ | x₉ | x₁₀ | x₁₁ |
| rᵢ | 0.736 | 0.813 | 0.651 | 0.841 | 0.745 | 0.667 | 0.838 | 0.807 | 0.618 | 0.796 | 0.760 |

The main control factors that have higher SVE remediation rates are analyzed by using grey correlation degree according to the data information given in the above table. The correlation degrees of the degrees of correlation r between the influence factors xᵢ and the simulated values y of the SVE removal rates are calculated, and the results can be seen in the table.

It can be known by the comparison that: x₄>x₇>x₂>x₈>x₁₀>x₁₁>x₅>x₁>x₆>x₃>x₉.

The calculation results of the correlation degrees and the difficulty degrees of acquiring the field data used as the basis of the selection of the parameters of the regression model. Thickness of unsaturated zone x₂ and permeability of unsaturated zone x₄ among the field parameters, pollution area x₇ among the pollution parameters, and flow rate inside well x₈, depth of extraction well x₁₀ and quantity of extraction wells x₁₁ among the extraction parameters are used as the 6 factors for establishing the multi-variable linear regression model.

Fourth step, by using grey-correlation-degree analysis, screening p main control factors that are correlated with the SVE remediation rate, and establishing a multi-variable equation of linear regression between the SVE remediation rates y as dependent variables and the main control factors Xᵢ (i=1, 2, . . . , p) as independent variables.

The establishing of the multi-variable equation of linear regression is as shown in Formula (7), and the 6 main control factors are substituted into the following formula to obtain:

Y′=b₀+b₂x₂+b₄x₄+b₇x₇+b₈x₈+b₁₀x₁₀+b₁₁x₁₁ (7)

The equation relation is obtained by calculating by using an SPSS software, as shown in Formula (8):

Y′=0.596+0.016x₂−3.52×10⁹×x₄+0.001x₇+3.71x₈−0.096x₁₀+0.034x₁₁ (8)

Fifth step, based on a result of simulation of the multi-variable equation of linear regression, by means of goodness of fit, performing test and judging fitting accuracy of the simulation; then judging by using significance test a significance of the model and a significance of the parameters of the multi-variable equation of linear regression; and finally performing accuracy comparison to the error of the model of the multi-variable equation of linear regression, to judge whether the accuracy satisfies design requirements.

The formula of the test of goodness of fit is as shown in Formula (9):

$${R}^{2} = \frac{E S S}{TSS} = 1 - \frac{R S S}{TSS} , 0 \leq {R}^{2} \leq 1 \qquad ( 9 )$$

wherein in the formula: TSS is a sum of squares for total, ESS is a regression sum of square, and RSS is a residual sum of square. R² is 0.819, which is close to 1, which indicates that the degree of fitting of the model of the multi-variable equation of linear regression is good.

The significance test F of the multi-variable equation of linear regression is as shown in Formula (10):

$$F = \frac{E S S / p}{R S S / ( n - p - 1 )} ∼ F ( p , n - p - 1 ) \qquad ( 10 )$$

wherein in the formula, n is a sample size, and p is a selected variable; if F≥F_{α}(p, n−p−1), the regression model has significance; and if F<F_{α}(p, n−p−1), the regression model has no significant difference, i.e., the regression model is not significant.

Among the parameters for testing the model that are provided automatically after the SPSS software has established the equation of linear regression, the parameter of the test of goodness of fit F is 6.047, the quantity of the variables (p) is 6, and the sample size (n) is 15. It can be looked up from the standard F statistical table that, when the significance α=0.05, F(6, 8)=3.581. It can be known that 6.047>3.581, and the equation has a very high significance, and is statistically significant.

2) The significance test of the parameters is as shown in Formula (11):

$$t = \frac{{b}_{i}}{S ( {b}_{i} )} \qquad ( 11 )$$

wherein in the formula, b₀ represents regression coefficients, and S(b) represents a standard deviation of the regression coefficients; if

$$\vert t \vert \geq {t}_{\frac{α}{2}} ( n - p - 1 ) ,$$

that indicates that xᵢ has a significant influence on y; and if

$$\vert t \vert < {t}_{\frac{α}{2}} ( n - p - 1 ) ,$$

that indicates that xᵢ does not have a significant influence on y; wherein a test of t-value of the parameters is able to be simplified into a probability test, and if a probability of the t-value is less than 0.05, the independent variable is significant. By calculating by using the SPSS software, Table 6 is obtained.

TABLE 6
the results of the t-test

| | Non-standardized | | | | |
|---|---|---|---|---|---|
| | coefficient | | Standardized | | |
| Module | bᵢ | S(bᵢ) | coefficient | t | Sig. |
| Constant quantity | 0.596 | 0.140 | | 4.246 | 0.003 |
| Thickness of | 0.016 | 0.019 | 0.356 | 0.842 | 0.424 |
| vadose zone (X₂) | | | | | |
| Permeability of | −3.52 × | 7.35 × | −0.124 | −0.478 | 0.645 |
| vadose zone (X₄) | 10⁹ | 10⁹ | | | |
| Pollution area (X₇) | 0.001 | 0 | 1.180 | 3.017 | 0.017 |
| Flow rate of | 3.710 | 1.992 | 0.951 | 1.862 | 0.100 |
| extraction well (X₈) | | | | | |
| Depth of extraction | −0.096 | 0.037 | −2.093 | −2.613 | 0.031 |
| well (X₁₀) | | | | | |
| Quantity of | 0.034 | 0.017 | 0.375 | 1.954 | 0.086 |
| extraction | | | | | |
| wells (X₁₁) | | | | | |

In the table the significance sig values of the constant and the independent variables x₇ an x₁₀ are less than 0.05, so the coefficients of the two variables and the constant are very significant, and the other 4 parameters are not significant. Because it has already been firstly calculated by using the grey correlation degree that the other 4 parameters closely relate to the SVE remediation efficiency, those parameters are reserved.

After the model test, the equation of linear regression that is finally obtained is as shown in Formula (12):

Y′=0.596+0.016x₂−3.52×10⁹×x₄+0.001x₇+3.71x₈−0.096x₁₀+0.034x₁₁ (12)

3) Error analysis of the multi-variable equation of linear regression comprises the particular steps of:

\textcircled{1} solving an mean value Y of raw data, as shown in Formula (13):

$$\overline{Y} = \frac{1}{n} {\sum }_{k = 1}^{n} Y ( k ) \qquad ( 13 )$$

\textcircled{2} solving a variance S₁ of the raw data, as shown in Formula (14):

$${S}_{1}^{2} = \frac{1}{n} {\sum }_{k = 1}^{n} {[ Y ( k ) - \overline{Y} ]}^{2} \qquad ( 14 )$$

\textcircled{3} solving a mean value P of residual errors, as shown in Formulas (15) and (16):

$$\begin{matrix}ɛ ( k ) = Y ( k ) - {Y}^{′} ( k ) & ( 15 ) \\ \overline{ɛ} = \frac{1}{n} {\sum }_{k = 1}^{n} ɛ ( k ) & ( 16 )\end{matrix}$$

\textcircled{4} solving a variance of the residual errors, as shown in Formula (17):

$${S}_{1}^{2} = \frac{1}{n} {\sum }_{k = 1}^{n} {[ ɛ ( k ) - \overline{ɛ} ]}^{2} \qquad ( 17 )$$

\textcircled{5} calculating a variance ratio C and a small-error probability P, as shown in Formulas (18) and (19):

$$\begin{matrix}C = \frac{{S}_{2}}{{S}_{1}} & ( 18 ) \\ P = \{ \vert ɛ ( k ) - \overline{ɛ} \vert < 0.6 \; 745 {S}_{1} \} & ( 19 )\end{matrix}$$

when the posterior-error ratio C is less than 0.5, the accuracy of the model is considered as qualified, and if C is smaller, the accuracy of the model is higher; and when the small-error probability P is greater than 0.8, the accuracy of the model is considered as qualified, and if P is larger, the accuracy of the model is higher. It is obtained by calculating that the posterior-error ratio C of the equation established this time is 0.43, which is less than 0.5, and the small-error probability P of the equation is 0.93, which is greater than 0.8. Therefore, the equation is qualified.

Sixth step, by using the established multi-variable equation of linear regression, substituting characteristic parameters of a new field that have been already known into the multi-variable equation of linear regression, and, by setting a target of the SVE remediation rate, screening an optimum combination of the SVE process parameters, to provide technical reference for parameter design of polluted-field SVE remediation technique.

By taking a factory in South China as the example, the multi-variable linear regression model of the SVE remediation rates is verified. The factory is located in East China, and the whole earth surface of the area where the factory is located is covered by loose deposit.

According to results of practical field reconnaissance, in-situ test and soil test, it can be known that the studied area is covered by Quaternary stratum. Quaternary stratum may be divided into lower pleistocene series (Q1), middle pleistocene series (Q2), upper pleistocene series (Q3) and Holocene series (Q4), and the main lithology is layers of clay and loam mingled with silty fine sand of fluvio-lacustrine deposit. The aquiclude in the factory is mainly formed by silt, mealy sand and fine sand of the upper pleistocene series of Quaternary, with a continuous and stable distribution. The underground water of the area is mainly phreatic water, and currently the burial depth of the underground water in the factory is 3˜4.5 m.

The parameter assignment, the calculating of the SVE remediation rates and the setting of the related parameters of the model are as shown in Table 7 and Table 8.

TABLE 7
the field parameters

| | Annual | Unsaturated zone | | | | Saturated zone | | | |
|---|---|---|---|---|---|---|---|---|---|
| | penetration | Soil | | | | Soil | | | |
| Field | amount/mm | type | Thickness/m | Porosity | Permeability/m² | type | Thickness/m | Porosity | Permeability/m² |
| 1 | 336.72 | Sandy | 3 | 0.4 | 3.07E−12 | Sandy | 3 | 0.4 | 3.07E−12 |
| | | soil | | | | soil | | | |

TABLE 8
the extraction parameters

| | pressure of | flow rate | Radius of | Depth of | Quantity of |
|---|---|---|---|---|---|
| | extraction | inside | influence/ | extraction | extraction |
| Field | well Pa | well m³/s | m | well/m | wells |
| 1 | 9.10E4 | 8.14E−03 | 7 | 3.5 | 5 |

By the simulation by using the TOUGH software, the calculation result of the SVE remediation rate is 67%. By referring to the practical conditions of the field of the factory, the numerical values of the 6 parameters are given respectively as: x₂ is 3 m, x₄ is 3.07E-12 m², x₇ is 220 m², x₈ is 0.00814 m³/s, x₁₀ is 3.5 m, x₁₁ is 5, and the value of the y that is calculated by the establishing of the multi-variable equation of linear regression is 72%. By comparing the results of the assessment, the simulated value of the SVE remediation rate of the TOUGH2 is 67%, and the value of the y that is calculated by the establishing of the multi-variable equation of linear regression is 72%. The error of the conclusion is within 5%, and the conclusion meets the expectation.

The SVE remediation of petroleum-type polluted fields is a complicated dynamics process. Because many influence factors of the SVE remediation rate exist, different influence factors contribute differently to the SVE remediation rate. Although the SVE technique is being extensively applied in many field studies, currently theoretical research, especially with respect to the mechanism of the migration of fluids in the SVE process, the mechanism of the mass transfer of pollutants, the in-field scale-up effect and the comprehensive mathematical simulation, is still insufficient. The accuracy of the processing design of the SVE remediation of polluted fields influences the grade of the remediation effect and the amount of the remediation cost, so to reasonably, quickly and accurately set the SVE process parameters is of vital importance for the accurate design of the SVE for typical polluted fields, the reduction of remediation time consumption, the saving of the remediation cost and so on.

The above are merely preferable particular embodiments of the present disclosure, and the protection scope of the present disclosure is not limited thereto. All of the variations or substitutions that a person skilled in the art can envisage within the technical scope disclosed by the present disclosure should fall within the protection scope of the present disclosure.

What is claimed is:

1. A method for designing SVE process parameters in a petroleum-type polluted field, wherein the method comprises the particular steps of:
first step, according to results of practical field reconnaissance, in-situ test and soil test, by referring to geological data of the field, clarifying conditions of the field such as geological type, soil type and distribution and underground-water distribution; and determining type and position of petroleum-type pollution;
second step, by referring to field parameters, pollution parameters and SVE process parameters, establishing by using a TOUGH software a remediation model with respect to SVE (Soil Vapor Extraction) of the petroleum-type polluted field, and obtaining SVE remediation rates under different conditions of influence factors;
wherein the SVE remediation rates reflect effect of the SVE on removal of the petroleum-type pollution in the field, and a calculating formula of the SVE remediation rate yₖ is as shown below:
$${y}_{k} = \frac{{m}_{k} - {m}_{k}^{′}}{{m}_{k}}$$
wherein in the formula: mₖ is a total mass of pollutants to be removed in an SVE pre-remediation model in a unit of kg; mₖ′ is a total mass of pollutants in an SVE post-remediation model in a unit of kg; wherein k=1, 2, 3, . . . , w, wherein w is a quantity of fields;
the third step, by using a method of grey-correlation-degree analysis, comparing and ranking correlation degrees of the SVE at the remediation rates of different influence factors for different field types, and screening p main control factors by using rank positions;
wherein a sequence of serial numbers of the different fields is counted as k (k=1, 2, 3, . . . n), wherein Xi are set as the influence factors of the SVE remediation rate, and xᵢ(k) is set as observed data of the factor xᵢ at the field k; then {xᵢ(k)|k=1, 2, 3, . . . , n} is an SVE-effect-action sequence, wherein i=1, 2, 3, . . . , m, and m is a quantity of the influence factors; and y(k) is set to be the SVE remediation rate of the field k;
wherein calculation of the correlation degrees r, is as shown below:
$${r}_{i} ( y , {x}_{i} ) = \frac{1}{n} {\sum }_{k = 1}^{n} {ζ}_{i} ( k )$$
wherein in the formula, ζᵢ(k) are correlation-degree coefficients;
fourth step, by using grey-correlation-degree analysis, screening p main control factors that are correlated with the SVE remediation rate, and establishing a multi-variable equation of linear regression between the remediation rate y as dependent variable and the main control factors Xᵢ (i=1, 2, . . . , p) as independent variables;
wherein the multi-variable equation of linear regression between y and the p main control factors Xᵢ is as shown below:
y=b₀+b₁X₁+b₂X₂+ . . . +bₚXₚ
wherein in the formula, among b₀, b₁, b₂, . . . , bₚ, b₀ is a constant quantity and the others are undetermined coefficients of the p main control factors; and solving by using least square method and the other undetermined coefficients of the multi-variable equation of linear regression;
fifth step, based on a result of simulation of the multi-variable equation of linear regression, by means of goodness of fit, performing test and judging accuracy of the simulation; then judging by using significance test a significance of the model and a significance of the parameters of the multi-variable equation of linear regression; and finally performing accuracy comparison to the error of the model of the multi-variable equation of linear regression, to judge whether the accuracy satisfies design requirements;
sixth step, by using the established multi-variable equation of linear regression, substituting characteristic parameters of a new field that have been already known into the multi-variable equation of linear regression, and, by setting a target of the SVE remediation rate, screening an optimum combination of the SVE process parameters, to provide technical reference for parameter design of polluted-field SVE remediation technique.

2. The method for designing SVE process parameters in a petroleum-type polluted field according to claim 1, wherein selection of the field in the first step is a representative typical land parcel or comprises dividing a land parcel according to geology into areas, and conceptualizing vertical soil-quality layers of the field, wherein the conceptualization of the soil-quality layers include a petroleum-type-organic-pollutant migrated and transformed soil layer and an SVE applied soil layer.

3. The method for designing SVE process parameters in a petroleum-type polluted field according to claim 1, wherein the second step comprises performing TOUGH-software conceptualization simulation by using multiple typical polluted fields, obtaining influences on the SVE remediation rate by the different influence factors of the field parameters, the pollution parameters and the SVE process parameters, obtaining the corresponding SVE remediation rate, and performing comparison-simulation to amplitudes of variation of magnitudes of the same influence factors.

4. The method for designing SVE process parameters in a petroleum-type polluted field according to claim 3, wherein in the second step, the selected influence factors of SVE remediation efficiency include, as the field parameters, infiltration capacity, thickness of unsaturated zone, porosity, permeability, oxygen content, temperature and pH value; as the pollution parameters, pollutant type, depth, width and area; and as the SVE process parameters, flow rate inside extraction well, radius of influence, depth of extraction well and quantity of extraction wells.

5. The method for designing SVE process parameters in a petroleum-type polluted field according to claim 3, wherein a process of the TOUGH-software simulation comprises selecting different modules according to different pollutants, wherein the modules include a T2VOC module and a TMVOC module; the T2VOC module is a three-phase flow of three components, and comprises simulations of numerical values of water, air and VOC, and the TMVOC modulemulation is simulations of numerical values of water, soil gas and multi-component mixed volatile organic compounds in a three-phase non-isothermal flow in a multi-layer, anisotropic, porous medium; and the process of the TOUGH-software simulation performs visualized operation by using a PetraSim software.

6. The method for designing SVE process parameters in a petroleum-type polluted field according to claim 5, wherein the process of the TOUGH-software simulation comprises, for different pollutants, by setting the same initial parameters such as leakage speed, leakage point and leakage duration, and the same field parameters and SVE process parameters, and by using an existing calibration model of experimentation data or field data, obtaining SVE remediation rates that are comparable.

7. The method for designing SVE process parameters in a petroleum-type polluted field according to claim 1, wherein in the fourth step, the calculation of the correlation degrees r, is as follows:
1st step, nondimensionalization, as shown below:
$${x}_{i}^{ ′} ( k ) = \frac{{x}_{i} ( k )}{{\overline{X}}_{ι}} , {\overline{X}}_{ι} = \frac{1}{n} {\sum }_{k = 1}^{n} {x}_{i} ( k ) \\ k = 1 , 2 , … , n$$
2nd step, evaluation of sequence of difference, as shown below:
Δᵢ(k)=|y(k)−xᵢ′(k)|

i=1,2, . . . ,m; k=1,2, . . . ,n
3rd step, solving two grades of maximum difference and minimum difference, as shown below:
$$M = {max}_{i} {max}_{k} {Δ}_{i} ( k ) m , m = {min}_{i} {min}_{k} {Δ}_{i} ( k ) m$$
4th step, solving correlation coefficients, as shown below:
$${ζ}_{i} ( k ) = \frac{m + ρ M}{{Δ}_{i} ( k ) + ρ M} , ρϵ [ 0 , 1 ]$$
$$i = 1 , 2 , … , m ; k = 1 , 2 , … , n$$
5th step, calculation of the correlation degrees rᵢ, as shown below:
$${r}_{i} ( y , {x}_{i} ) = \frac{1}{n} {\sum }_{k = 1}^{n} {ζ}_{i} ( k )$$
$$i = 1 , 2 , … , m$$

8. The method for designing SVE process parameters in a petroleum-type polluted field according to claim 1, wherein in the fifth step, a fitting degree of the model of the multi-variable equation of linear regression is tested by using goodness of fit;
wherein a formula of the test of goodness of fit is as shown below:
$${R}^{2} = \frac{E S S}{TSS} = 1 - \frac{R S S}{TSS} , 0 \leq {R}^{2} \leq 1$$
wherein in the formula: TSS is a sum of squares for total, ESS is a regression sum of square, and RSS is a residual sum of square; and if R² is closer to 1, a degree of fitting of the model of the multi-variable equation of linear regression is better.

9. The method for designing SVE process parameters in a petroleum-type polluted field according to claim 1, wherein in the fifth step, the significance test of the multi-variable equation of linear regression is as shown below:
$$F = \frac{E S S / p}{R S S / ( n - p - 1 )} ∼ F ( p , n - p - 1 )$$
wherein in the formula, n is a sample size, and p is a selected variable; if F≥F_{α}(p, n−p−1), the regression model has significance; and if F<F_{α}(p, n−p−1), the regression model has no significant difference, i.e., the regression model is not significant;
wherein the significance test of the parameters is as shown below:
$$t = \frac{{b}_{i}}{S ( {b}_{i} )}$$
wherein in the formula, b₀ represents regression coefficients, and S(b) represents a standard deviation of the regression coefficients; if
$$\vert t \vert \geq {t}_{\frac{α}{2}} ( n - p - 1 ) ,$$
that indicates that xᵢ has a significant influence on y; and if
$$\vert t \vert < {t}_{\frac{α}{2}} ( n - p - 1 ) ,$$
that indicates that xᵢ does not have a significant influence on y; wherein a test of t-value of the parameters is able to be simplified into a probability test, and if a probability of the t-value is less than 0.05, the independent variable is significant.

10. The method for designing SVE process parameters in a petroleum-type polluted field according to claim 1, wherein in the fifth step, error analysis of the multi-variable equation of linear regression comprises the particular steps of:
\textcircled{1} solving an mean value Y of raw data, as shown below:
$$\overline{Y} = \frac{1}{n} {\sum }_{k = 1}^{n} Y ( k )$$
\textcircled{2} solving a variance S₁ of the raw data, as shown below:
$${S}_{1}^{2} = \frac{1}{n} {\sum }_{k = 1}^{n} {[ Y ( k ) - \overline{Y} ]}^{2}$$
\textcircled{3} solving a mean value ε of residual errors, as shown below:
$$ɛ ( k ) = Y ( k ) - {Y}^{′} ( k )$$
$$\overline{ɛ} = \frac{1}{n} {\sum }_{k = 1}^{n} ɛ ( k )$$
\textcircled{4} solving a variance of the residual errors, as shown below:
$${S}_{1}^{2} = \frac{1}{n} {\sum }_{k = 1}^{n} {[ ɛ ( k ) - \overline{ɛ} ]}^{2}$$
\textcircled{5} calculating a variance ratio C and a small-error probability P, as shown below:
$$C = \frac{{S}_{2}}{{S}_{1}}$$
$$P = \{ \vert ɛ ( k ) - \overline{ɛ} \vert < 0. 6745 {S}_{1} \}$$
when the posterior-error ratio C is less than 0.5, the accuracy of the model is considered as qualified, and if C is smaller, the accuracy of the model is higher; and when the small-error probability P is greater than 0.8, the accuracy of the model is considered as qualified, and if P is larger, the accuracy of the model is higher.
